(19) United States
(12) Patent Application Publication
(10) Pub. No.: US 2026/0346940 A1
(43) Pub. Date: Nov. 5, 2026

(54) Ride-On Platform Virtual Reality System

(71) Applicant: Ryan Michael Moloney, Mansfield, MA (US)

(72) Inventor: Ryan Michael Moloney, Mansfield, MA (US)

(21) Appl. No.: 19/745,190

(22) Filed: Jul. 17, 2026

Related U.S. Application Data
(62) Division of application No. 18/815,366, filed on Aug. 26, 2024.
(60) Provisional application No. 63/580,375, filed on Sep. 3, 2023.

(51) Int. Cl. B62K 9/00; B60W 10/119; G06T 19/00

(52) U.S. Cl. CPC B62K 9/00; B60W 10/119; G06T 19/00

(57) ABSTRACT

A vehicle includes a plurality of drive subsystems coupled to a chassis, each including a drive motor and a steering motor. A controller parses drive commands and odometry data generated by the drive motors and steering motors, and controls the motors as a function of the drive commands and the odometry data. The vehicle can be controlled through remote commands from a system tracking both the vehicle and a virtual vehicle within a virtual environment.

### RELATED APPLICATION

This Application is a divisional of U.S. application Ser. No. 18/815,366, filed on Aug. 26, 2024, which claims the benefit of U.S. Provisional Application No. 63/580,375, filed on Sep. 3, 2023. The entire teachings of the above application are incorporated herein by reference.

### BACKGROUND

Go-karts have long been a popular form of recreational activity, providing enthusiasts of all ages with the thrill of high-speed racing in a controlled environment. Traditionally, go-karts are small, four-wheeled vehicles designed for use on tracks, where drivers can experience the excitement of racing close to the ground. Over the years, advancements in technology have led to improvements in safety features, materials, and motor capabilities, making go-kart racing more accessible and enjoyable. Additionally, the sport has evolved from casual leisure to a competitive arena, where enthusiasts and professionals alike participate in organized events and competitions.

Virtual reality (VR) has emerged as a transformative technology in recent years, offering immersive experiences that allow users to interact with digital environments in a highly realistic way. Initially developed for gaming and entertainment, VR technology has rapidly expanded into various fields, including education, training, and therapy. The ability to simulate real-world scenarios and create interactive, 360-degree environments has made VR an invaluable tool for experiential learning and skill development. With continuous advancements in hardware and software, VR systems are becoming more sophisticated and accessible, offering a growing range of applications that extend beyond traditional entertainment mediums.

### SUMMARY

Example embodiments pertain to the field of virtual reality and interactive entertainment systems, specifically to a ride-on platform that simulates driving experiences.

Go-kart establishments typically require significant capital investment on design and construction of the courses, especially the more modern multi-level tracks. And while these establishments may be well-executed, they tend to cater to the more extreme end of the go-karting experience, often appealing primarily to thrill-seekers and experienced drivers. This focus on high-speed, adrenaline-pumping experiences can inadvertently exclude casual participants, families, and those who might prefer a more accessible, less intense introduction to the sport. As a result, there is a gap in the market for go-karting venues that offer a more inclusive environment, where safety, accessibility, and enjoyment for all skill levels are prioritized without compromising the excitement of the experience.

Despite the remarkable advancements in VR technology and its growing popularity, the platform still faces significant challenges that impact user experience and hinder broader adoption. One major limitation of VR is that users are often confined to a static seated or standing position, with movement generally restricted to a small physical space. This can lead to repetitive gameplay, such as stationary shooting, or experiences where the user moves within the virtual world but may suffer from motion sickness due to the disconnect between the visual motion and the lack of corresponding physical movement.

Example embodiments provide a virtual reality system within a driving experience, enabling the rider to experience various scenarios that would otherwise be impossible to recreate in a real environment. This solves the problem of requiring major infrastructure work to produce real life race courses and scenery.

The addition of an omnidirectional vehicle to a driving experience allows the rider to experience maneuvers in a controlled manner that would otherwise be chaotic and dangerous to perform. This solves the problem of requiring the vehicle's wheels to lose traction with the ground, therefore providing a safer way for the rider to experience drifting and spinout maneuvers.

The addition of an omnidirectional vehicle to a virtual reality game provides the movement and physical feedback that allows a person to feel an approximation to the motion their eyes see in the virtual reality system. This provides a solution to the problem of mismatched visual and physical stimuli that results in fatigue and motion sickness when using only a virtual reality system.

The use of an omnidirectional vehicle with an electronic drive system (drive-by-wire) provides a method for seamlessly integrating the effects and boundaries of a virtual environment into the physical motion of the vehicle. This solves the need for physical boundaries and complex mechanical systems that otherwise would be required to physically disconnect the rider's driving controls from the vehicle's driving system. This also provides much greater safety and accessibility, allowing people of all ages and driving abilities to participate.

The compact and powerful nature of the wheel mechanisms provides a means to construct a small, single-seater vehicle that is capable of exciting acceleration, speed, and handling. This solves the technical problem of constructing a vehicle of this nature using current rotating drive wheel technology.

This overall solution has advantages over other similar vein solutions. This solution leverages omnidirectional electronic drive vehicles, which provide much more flexibility and excitement with regards to maneuvering and driving dynamics, over other solutions that rely on standard electric go-karts. This solution makes use of virtual reality, which provides a much more immersive experience than other solutions that use projection mapping onto 2D surfaces. The virtual environments of this solution provide the ability to design it once and deploy as many times as needed, whereas other physical environment-based solutions require each duplicate environment to be constructed separately. This also means that this solution can be quickly and temporarily deployed instead of requiring permanent infrastructure.

The advantage of the wheel mechanisms over other similar ones is that it is cheap and compact. This dramatically improves the versatility of the applications.

While this overall system is intended for the Leisure & Entertainment market, the vehicle and the wheel mechanisms can be used in other applications such as Healthcare, Cinema, Transportation, and especially Robotics.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram of a motorized vehicle in one embodiment.

FIG. 2 is a diagram of a system for operating an omnidirectional vehicle in one embodiment.

FIG. 3 illustrates a motorized rotating driving fixture in one embodiment.

FIG. 4 illustrates a system for managing the control of one or more vehicles in one embodiment.

FIG. 5 depicts a ride-on platform virtual reality system in one embodiment.

FIGS. 6A-I illustrate example processes of determining wheel velocity and steering angle.

FIGS. 7A-I are top-down scenes illustrating example operations of a vehicle and control system.

### DETAILED DESCRIPTION

A description of example embodiments follows.

### Explanation of Terms

“Simulation” refers to any and all computing hardware and accompanying software which process and render virtual environments, tracking system data, and rider controls, and which provide rendered visual, audio, and haptic feedback to the rider, as well as motion control data for the vehicle.
“Tracking System” refers to any and all hardware and accompanying software which is configured to determine the position and orientation of both the vehicles and the virtual reality systems within a physical environment.
“Vehicle” refers to any and all embodiments of a physical or virtual vessel that moves about a physical or virtual space and has the capacity to house one or more individuals.
“User”, “Rider”, and “Driver” refer to any and all individuals situated in or on a vehicle who may or may not have influence over the vehicle's motion and behavior.
“Virtual Reality” refers to any and all forms of altering one's view of reality using digital overlays, including fully immersive digital environments.

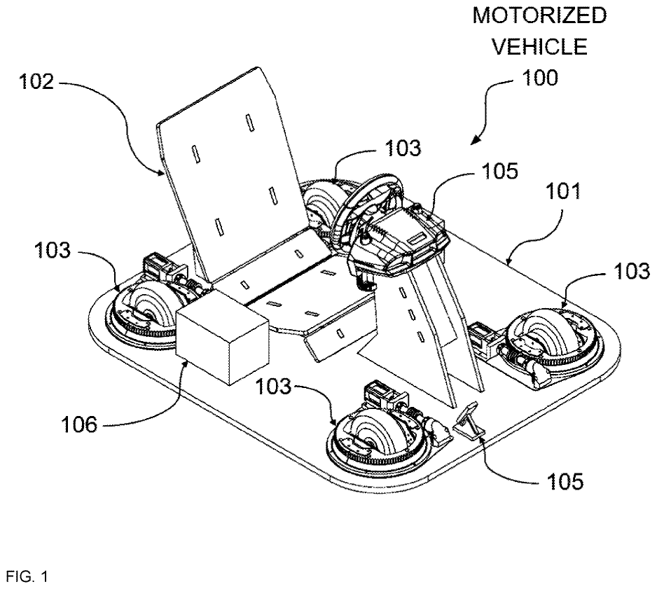

FIG. 1 illustrates a motorized vehicle 100 in one embodiment. The motorized vehicle 100 suitable for a rider and capable of horizontally rotating and propelling itself in any direction along a surface due to omnidirectional wheel fixtures 103 (the drive subsystems). The vehicle 100 consists of a frame 101 (the chassis), and mounted on which are propulsion controls 105 (the user controls), a rider's mounting fixture 102, power and control systems 106 (the controller), and the omnidirectional wheel fixtures 103. The vehicle 100 could use three or four wheel fixtures 103 (or more). A control panel can be used by the rider to select between multiple control schemas (the drive schema). Each control schema determines the motion and behavior of the vehicle 100 when given various conditions.

A platform 101 houses a set of wheel mechanisms 103 which are controlled by a control system using inputs from a steering wheel and electronic throttle 105. The platform 101 also houses a seat 102 for a rider as well as a power system 106.

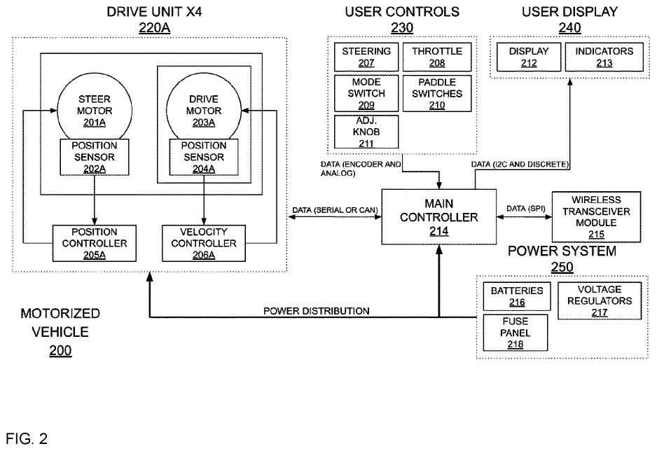

FIG. 2 illustrates a system 200 for operating an omnidirectional vehicle. Each drive unit 220A uses a position controller 205A which, when receiving position commands from the main controller 214, will apply appropriate power to the steer motor 201A utilizing position feedback from the position sensor 202A. Each drive unit 220A also uses a velocity controller 206A which, when receiving velocity commands from the main controller 214, will apply appropriate power to the drive motor 203A utilizing position feedback from the position sensor 204A.

The power system 250 provides a source of voltage regulated 217 and fused 218 battery power 216 for the drive units 220A and main controller 214 to use.

The main controller 214 runs a control loop (see below) which takes in user controls 230, and depending on the user controls 230, current vehicle dynamics, and which drive schema is selected, will produce output commands to be sent to each of the drive units 220A.

The wireless transceiver module 215 may be used to communicate data between the vehicle and a remote server regarding the user controls 230, the vehicle's dynamics, and commands from the server.

The user controls 230 allow the user to command the vehicle using a steering wheel 207 for steering commands, a throttle 208 for throttle commands, a mode switch 209 for selecting the drive schema, paddle switches 210 for commanding special maneuvers, and an adjustment knob 211 for dialing in certain drive schema parameters.

The user display 240 contains a display 212 for displaying to the user various information about the vehicle, and indicators 213 for notifying the user of vehicle subsystem states, for example whether or not the drive subsystems are enabled.

The vehicle's controller 214 will start by gathering input data from the user controls 230. Using this information, the controller 214 will determine the current selected control mode. Odometry data will then be collected from the motor controllers 205A (through 205D) and 206A (through 206D) in each of the wheel mechanism subsystems 220A (through 220D). Depending on the control mode selected, the controller 214 will either run a control process using the above data in a “local control mode”, or the controller 214 will send and receive data from a host system in a “remote control mode”. The resulting data from this previous step will be sent to the motor controllers 205A (through 205D) and 206A (through 206D) in each of the wheel mechanism subsystems 220A (through 220D) in the form of position and velocity commands. Finally, any relevant information will be displayed for the rider on the user display 240.

### Examples of Control Schemas

Standard Driving Mode: An accelerator lever articulated by the rider powers the wheels and propels the vehicle forward. Releasing the accelerator invokes an electronic braking mechanism. A rotating handle is used to determine the direction that the front wheel(s) is(are) facing, while the rear wheels are always facing forward. The resulting behavior is much like that of a standard car.
Drift Driving Mode: An accelerator lever articulated by the rider propels the drive wheels forward. Releasing the accelerator invokes an electronic braking mechanism. A rotating handle is used to determine the direction that the front wheel(s) is(are) facing. The direction the rear wheels are facing is determined by a control process that uses an IMU (inertial measurement unit) to sense the lateral acceleration forces of the vehicle as it drives around. The general description of this control process is as the lateral forces increase while the vehicle is progressing through a turn, the rear wheels will rotate outwards, causing a “drifting” behavior as if the rear wheels had lost traction with the driving surface. The intensity in which the rear wheels turn outwards given a certain lateral force can be adjusted by a control knob on the vehicle.
Custom Pivot Mode: The vehicle drives much like the described mode above (Standard Driving Mode) with the exception that the rear wheels will also rotate as the front wheels rotate, but not necessarily at the same rate or in the same direction as the front wheels. With an adjustment knob, the rider may select the location of a virtual point along the length and center of the vehicle in which the vehicle will pivot when turning. The knob in a default position will not change the direction of the rear wheels at all and the vehicle will pivot about the center of the rear wheels when turning. The knob adjusted such that the pivot point is behind the rear wheels will rotate the rear wheels in some relative amount of the steering wheels and in the same direction, while the knob adjusted such that the pivot point is in front of the rear wheels will rotate the rear wheels in some relative amount of the steering wheels but in the opposite direction.
Flight Stick and Throttle Control Mode: Using an electronic flight control stick capable of X, Y, and yaw motion controls and a single vector throttle, a rider will be able to control the translational velocity and direction and rotation of the vehicle.
External Control Mode: A control schema in which direction, velocity, and rotation commands are given to the vehicle's control unit from an external source. The vehicle may report its telemetry feedback to the command source, or the command source may have other means to incorporate the vehicle's telemetry feedback, such as tracking sensors mounted on the vehicle and within the area infrastructure. This control schema could be utilized in some sort of a pre-choreographed movement routine in which the rider may also be wearing a virtual reality system, such that the movements experienced in the virtual world are being reproduced at some rate in reality.

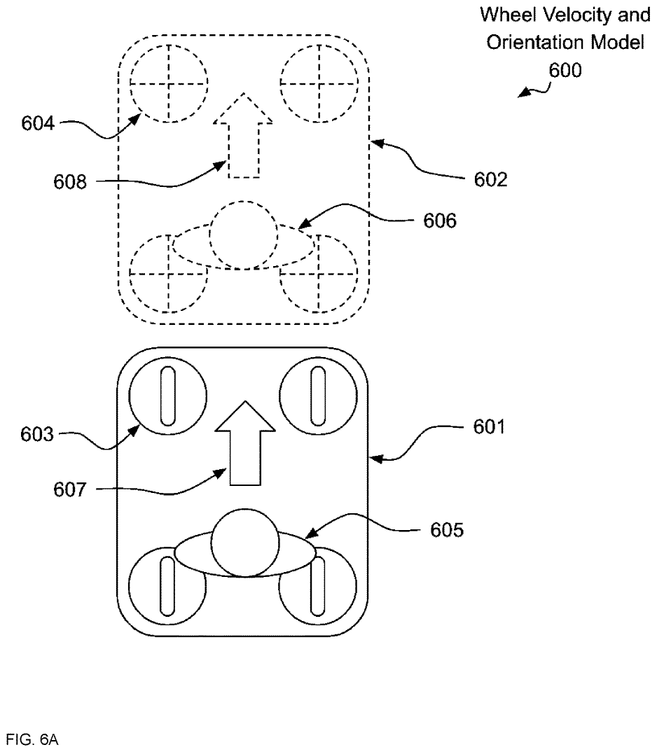

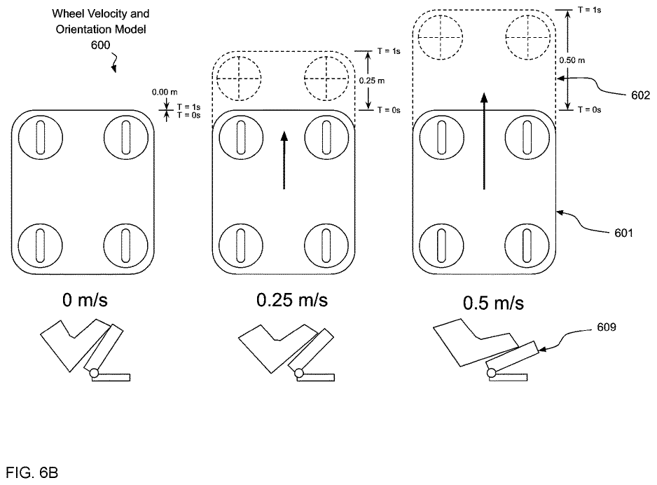

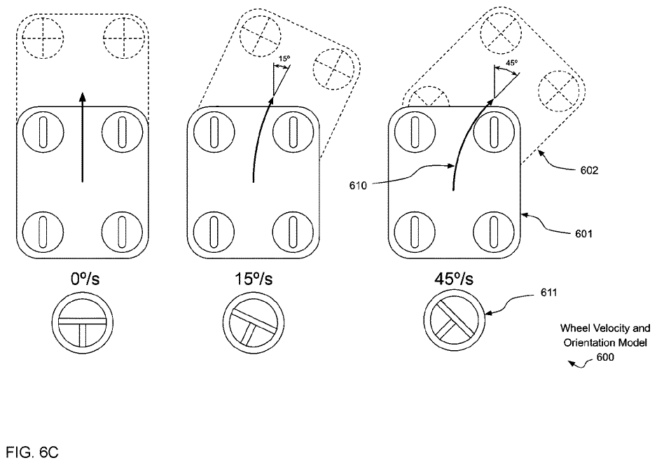

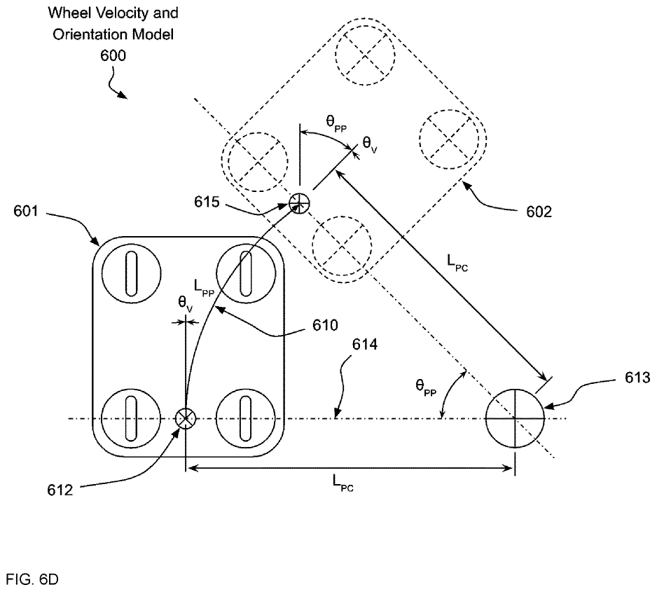

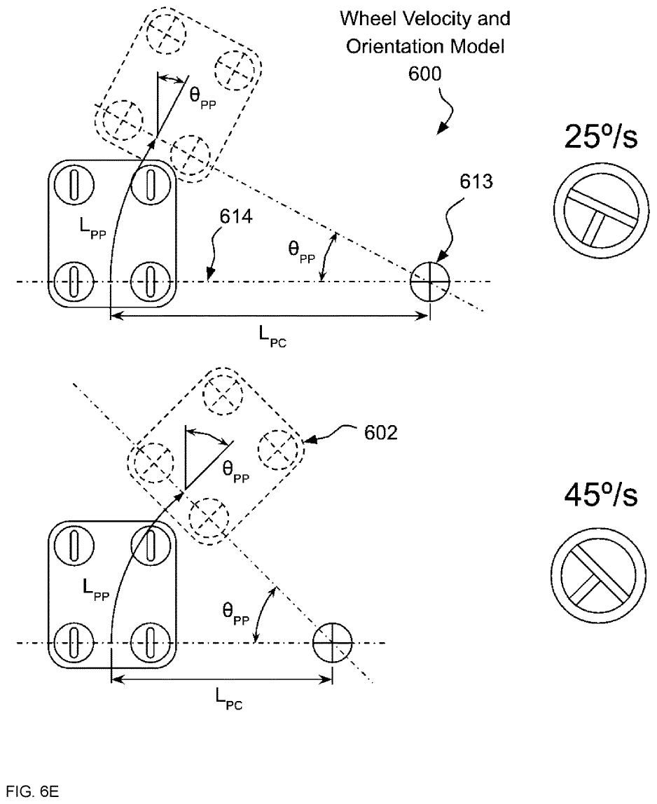

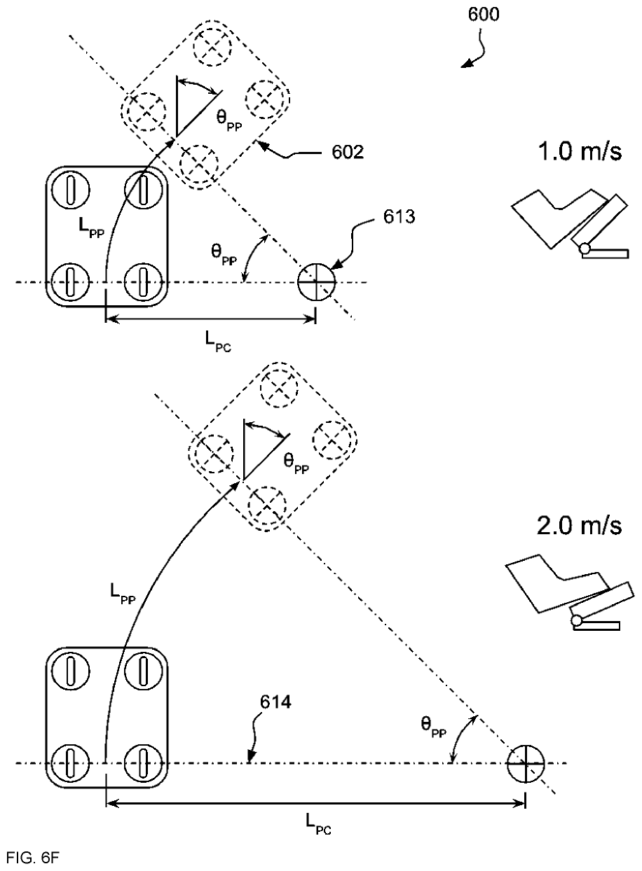

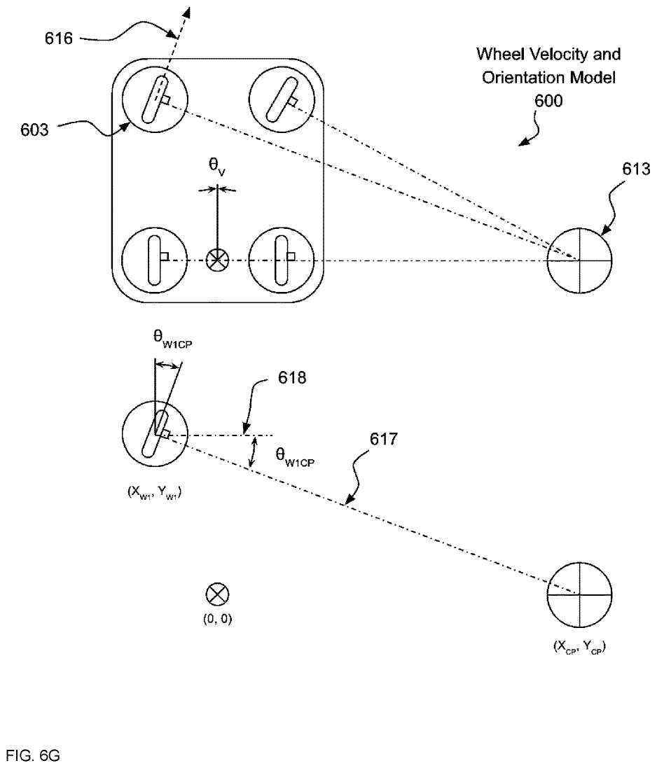

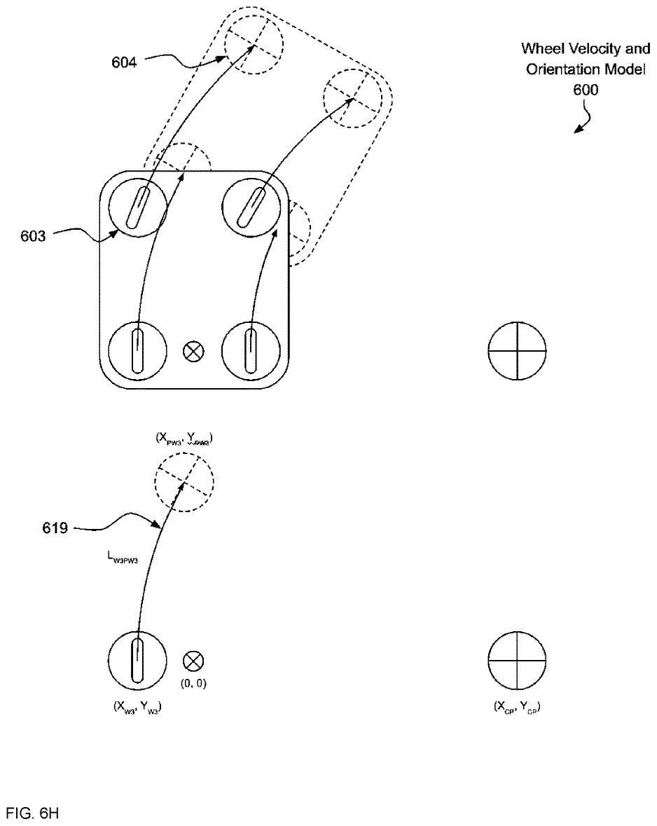

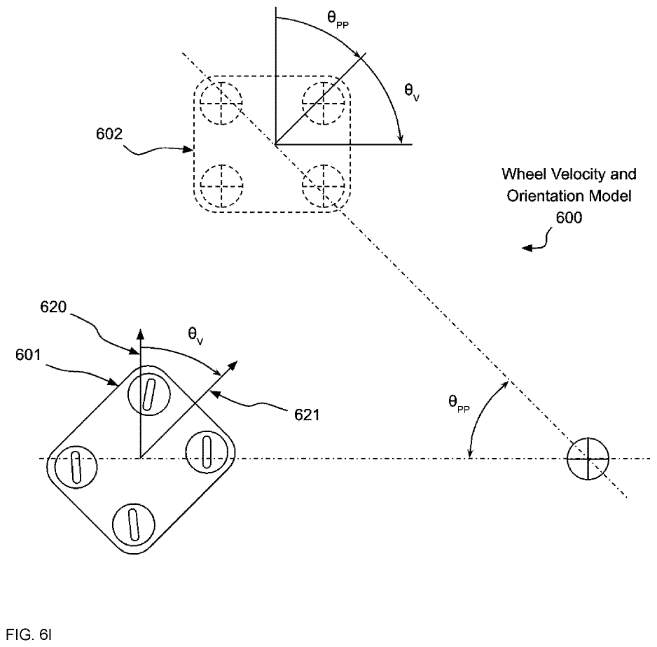

Example control schemas are described in further detail below with reference to FIGS. 6A-I.

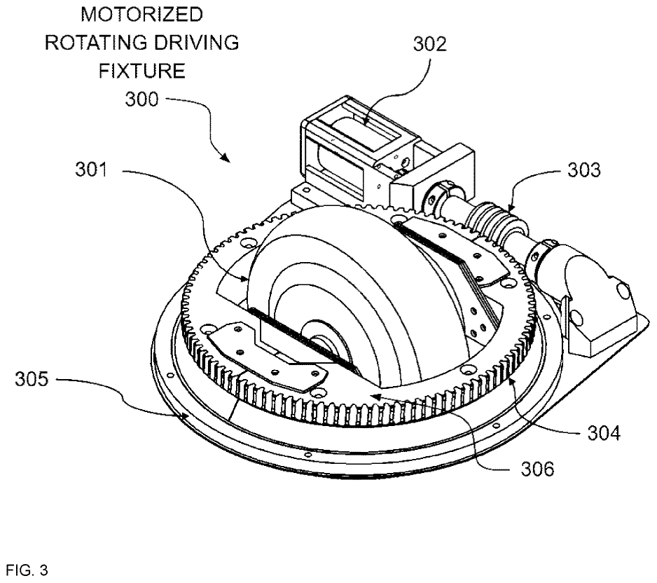

FIG. 3 illustrates a motorized rotating driving fixture 300 in one embodiment. An electronic hub-motor driven wheel 301 with a rounded profile (the front cross section profile) sits within a larger horizontally rotating structure 306 (the axle). The structure 306 containing the wheel 301 rotates about an axis (the vertical axis) running roughly through the center of the wheel 301 vertically, and mounts to a static frame (the chassis) using a large turntable bearing 305. The rotating structure 306 containing the drive wheel 301 is wrapped horizontally in gear teeth 304 (the output gear) that mate with a worm gear 303 (the input of the gear train). This worm gear 303 is driven by a high speed motor 302 (the steering motor) that is mounted to the static frame. As this motor 302 spins, the worm gear 303 also spins, driving the inner rotating structure 306 to rotate in place.

Depicted in FIG. 3 is a single wheel mechanism 300. An electric hub motor wheel 301 is affixed within a rotating fixture 306 wrapped in gear teeth 304. This rotating fixture is mounted to a large bearing 305, and its rotational movement is mechanically commanded by the worm gear 303, which in turn is powered by the steering motor 302.

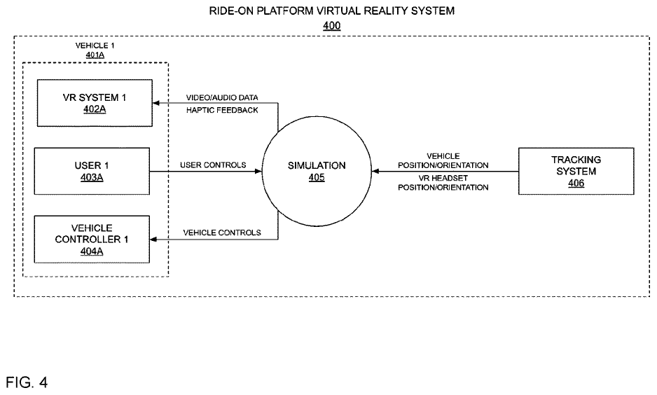

FIG. 4 illustrates a system 400 (the riding system) for managing the control of one or more vehicles 401A, in which the motion (the orientation and velocity of the wheels) of each vehicle 401A is controlled by some combination of the user's 403A driving controls (the drive commands) and the simulation 405 vehicle control output (the remote command).

A position tracking system 406 determines the position and orientation of each vehicle 401A, as well as the position and orientation of each virtual reality system 402A, as they move about the environment.

The rider wears a virtual reality system 402A, where they are able to perceive their view into a virtual space relative to their position and orientation within a physical space.

The simulation 405, running either locally on the vehicle 401A, remotely on a server, or some combination thereof, receives inputs regarding each vehicle 401A position and orientation and each virtual reality system 402A position and orientation from the tracking system 406, as well as each rider 403A driving controls, and generates vehicle control outputs for each vehicle controller 404A, as well as video, audio, and haptic feedback for each virtual reality system 402A.

The simulation 405 utilizes the vehicle position and orientation information to update in real time the position and orientation of a representative virtual vehicle in the virtual space. The remote commands to be sent back to each vehicle controller 404A are based on multiple factors including position and orientation of the physical vehicle and virtual vehicle, the user's drive commands, and virtual environmental factors such as ground traction, interactions with virtual objects, and virtual boundaries.

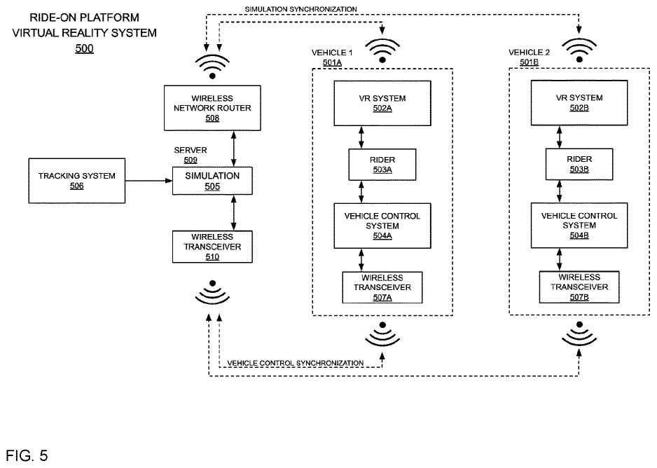

Depicted in FIG. 5 is a ride-on platform virtual reality system 500 in one embodiment. A server 509 runs a simulation 505 which takes in user vehicle controls from a wireless transceiver 510 and outputs vehicle controls back to the wireless transceiver 510. A tracking system 506 provides the simulation 505 with the position and orientation of each vehicle 501A and 501B and the position and orientation of each virtual reality system 502A and 502B. A wireless network router 508 communicates the data required to synchronize the simulation 505 with each virtual reality system 502A and 502B.

A series of vehicles 501A, 501B (and optionally additional vehicles not shown), each with their own wireless transceivers 507A and 507B, communicate their user controls and receive vehicle controls from the house server 509. Each vehicle 501A and 501B has a vehicle control system 504A and 504B which takes in the vehicle controls to execute on each vehicle 501A and 501B. The user controls of each vehicle 501A and 501B are communicated through their main controller 504A and 504B to their wireless transceiver 507A and 507B.

Each rider 503A and 503B dons a virtual reality system 502A and 502B, allowing them to perceive their view into the simulated virtual environment. Each rider 503A and 503B can manipulate their driving controls 504A and 504B which are then communicated to the simulation 505 in order to influence the motion and behavior of any representative virtual vehicle in the simulation 505.

FIGS. 6A through 6I illustrate example processes of determining wheel velocity and steering angle. FIG. 6A illustrates a system 600 in which vehicle linear velocity commands and vehicle angular velocity commands are used to determine the wheel velocity and wheel orientation commands.

The vehicle 601 is a representation of the initial position and orientation of a physical vehicle, along with rotating drive wheel fixtures 603, representing the position and orientation of physical drive wheel fixtures. A user 605 is situated on the vehicle 601 and is facing in a vehicle forward direction 607, both omitted in subsequent figures.

The projected vehicle 602 is a representation of the intended position and orientation of the vehicle 601 in a specified time step, along with representative projected wheel fixture positions 604. A representative user 606 is facing a vehicle forward direction 608, both omitted in subsequent figures.

FIG. 6B illustrates an interaction between the vehicle 601 and projected vehicle 602 when given a linear velocity command. The amount the vehicle 601 intends to travel in a specified time step is determined by this linear velocity command and is represented by the position of the projected vehicle 602.

In this example, a foot actuated throttle 609 is commanding a desired linear velocity. The projected vehicle 602 position is adjusted to represent the intended position of the vehicle 601 in 1 second given this commanded velocity.

FIG. 6C illustrates an interaction between the vehicle 601 and projected vehicle 602 when given an angular velocity command. The amount the vehicle 601 intends to rotate in a specified time step is determined by this angular velocity command.

The projected vehicle 602 articulates along an arc 610, the arc angle representing the amount the vehicle 601 intends to rotate in a specified time step, the arc length representing the amount the vehicle 601 intends to travel in a specified time step.

In this example, a steering wheel 611 is commanding a desired angular velocity. The position and orientation of the projected vehicle 602 is adjusted to represent the intended position and orientation of the vehicle 601 in 1 second given this commanded angular velocity.

FIG. 6D outlines the components of the model 600. A pivot point 612 located on or off the vehicle 601 represents the desired point in which the vehicle 601 would rotate about given a zero turning radius command.

The arc 610 is composed of an arc length L_{PP}, determined by the linear velocity command, and an angle θ_{PP}, determined by the angular velocity command. The arc's radius L_{PC}, is derived using the formula radius=arc length/arc angle.

The arc 610 is situated to begin at pivot point 612 of the vehicle 601 and end at the projected pivot point 615 of the virtual vehicle 602, creating a vehicle turning radius centerpoint 613. The vehicle turning radius centerpoint 613 sits on a horizontal axis 614 intersecting the vehicle pivot point 612. The vehicle 601 may be rotated at an angle θ_{V} about the pivot point 612.

The projected pivot point 615 of the projected vehicle 602 is situated at the end of the arc 610 and maintains a length L_{PC} from the vehicle turning radius centerpoint 613. The projected vehicle 602 is rotated about the projected pivot point by the angle θ_{PP} and is further rotated by any additional angle θ_{V}.

FIG. 6E demonstrates the commanded angular velocity effect on the arc angle θ_{PP}, affecting the arc radius L_{PC}, thus moving the vehicle turning radius centerpoint 613 position along the horizontal axis 614 and adjusting the position and orientation of the projected vehicle 602. The commanded linear velocities are the same, therefore the arc length L_{PP} is unchanged.

FIG. 6F demonstrates the commanded linear velocity effect on arc length L_{PP}, affecting the arc radius L_{PC}, thus moving the vehicle turning radius centerpoint 613 position along the horizontal axis 614 and adjusting the projected vehicle 602 position. The commanded angular velocities are the same, therefore the arc angle θ_{PP} is unchanged.

FIG. 6G illustrates the method in which the desired orientation of each drive wheel fixture 603 is determined. A line 617 perpendicular to each wheel's direction of travel 616 is projected to intersect the vehicle turning radius centerpoint 613. The angle of this line 617 relative to vehicle horizontal 618 represents the angle θ_{W1CP}.

To determine a wheel angle:

θ_{W1CP}=(atan 2(X_{CP}−X_{W1}, Y_{CP}−Y_{W1})*180/pi)−θ_{V}
If X_{CP}>=0.0, then add −90 degrees to θ_{W1CP}
If X_{CP}<0.0, then add 90 degrees to θ_{W1CP}

FIG. 6H illustrates the method for determining the desired velocity of each drive wheel fixture 603. An arc 619 is projected from the rotational centerpoint of a wheel 603 to the rotational centerpoint of the associated projected wheel 604. The length L_{W3PW3} of this arc 619 represents the desired wheel velocity.

To determine a wheel arc length:

BAX=X_{W3}−X_{CP}

BAY=Y_{W3}−Y_{CP}

BCX=X_{PW3}−X_{CP}

BCY=Y_{PW3}−Y_{CP}

dotprod=(BAX*BCX)+(BAY*BCY)

BALen=sqrt(sq(BAX)+sq(BAY))

BCLen=sqrt(sq(BCX)+sq(BCY))

vecLengths=BALen*BCLen

L_{W3PW3}=BALen*acos(dotprod/vecLengths)

FIG. 6I illustrates a method for engaging into a drifting maneuver. The vehicle 601 is rotated to a desired angle θ_{V}, causing the direction of vehicle motion 620 to be different from the direction of vehicle forward 621. The projected vehicle 602 is rotated to the combined angles θ_{V} and θ_{PP}.

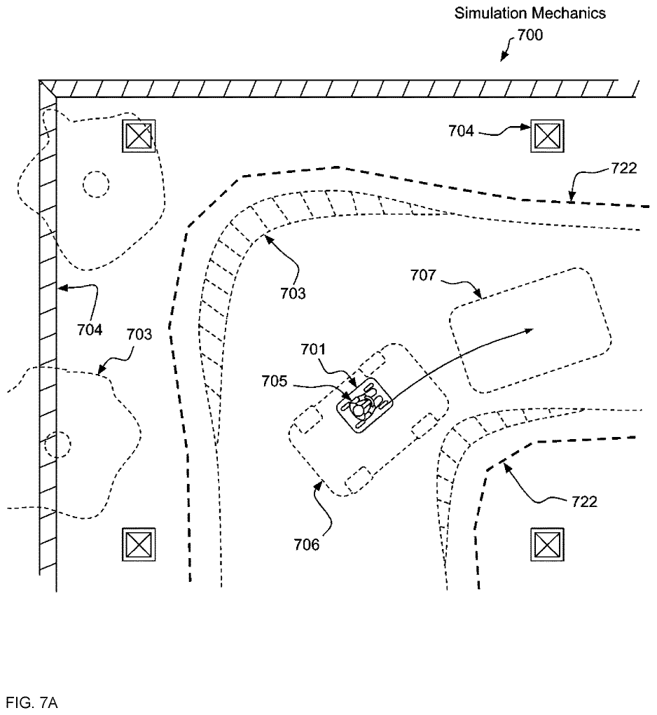

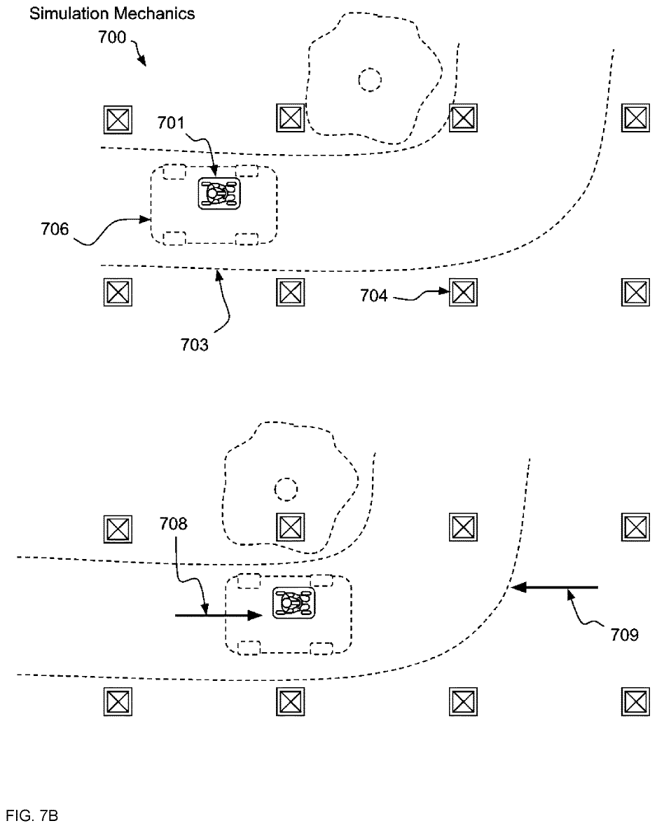

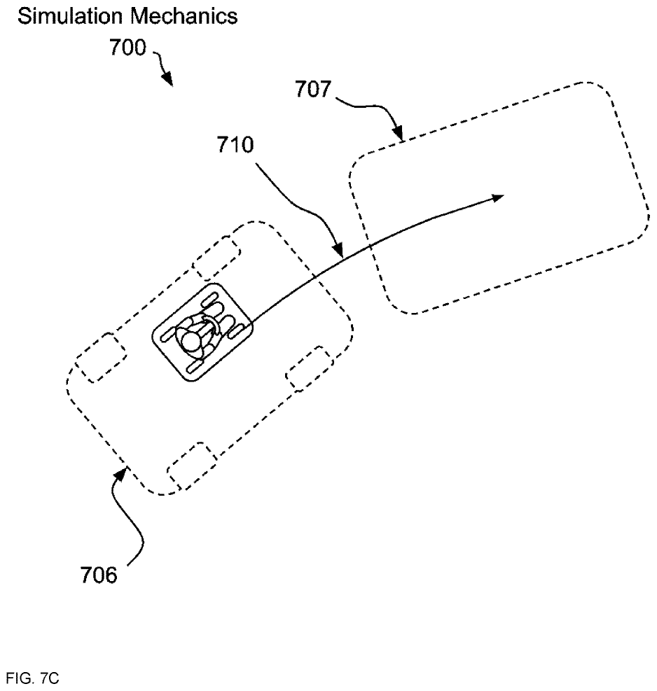

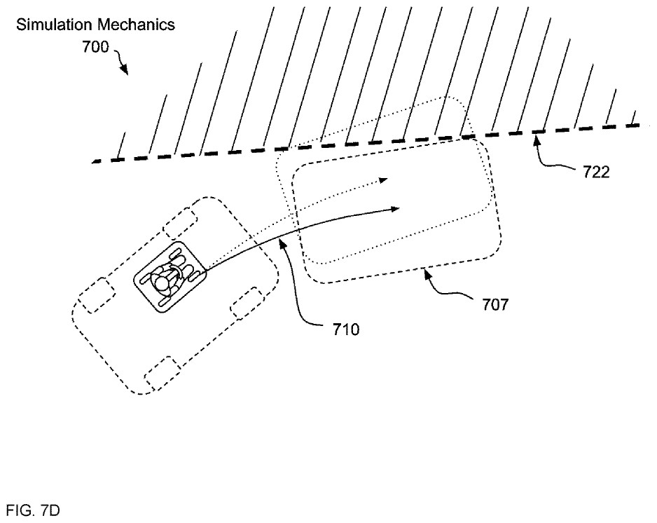

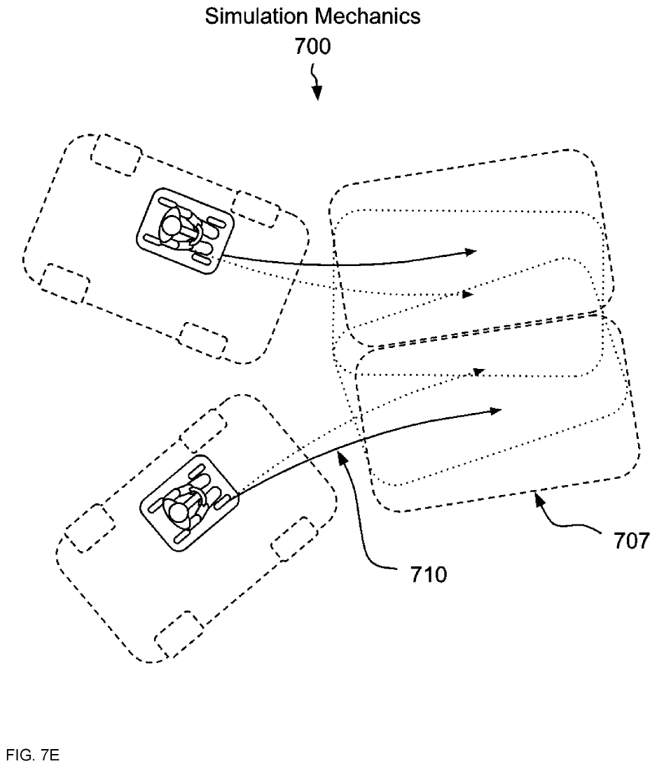

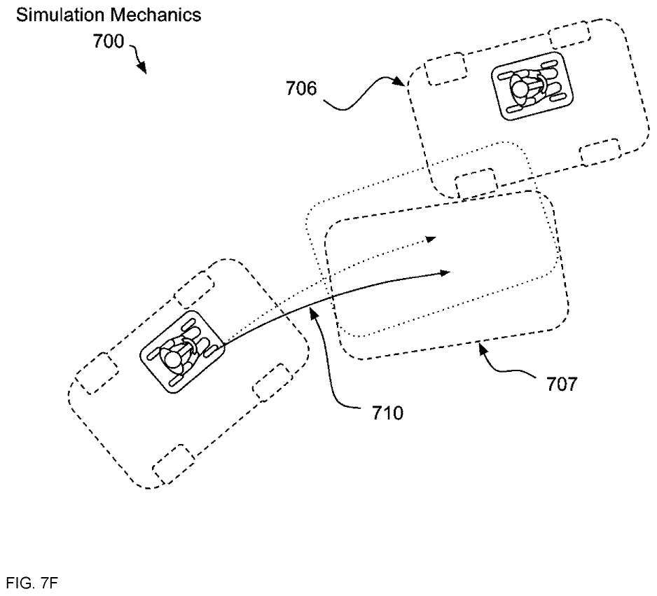

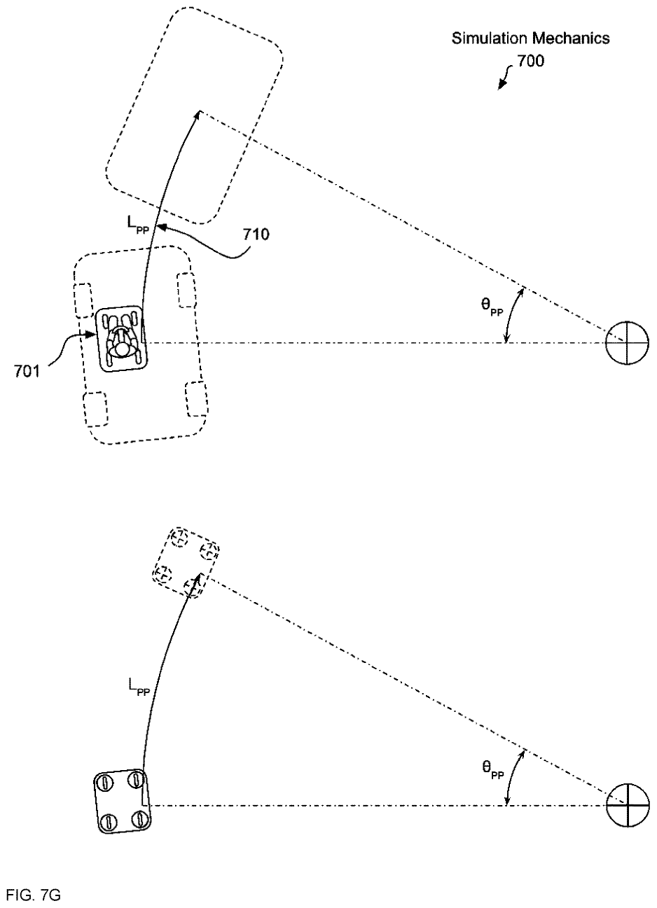

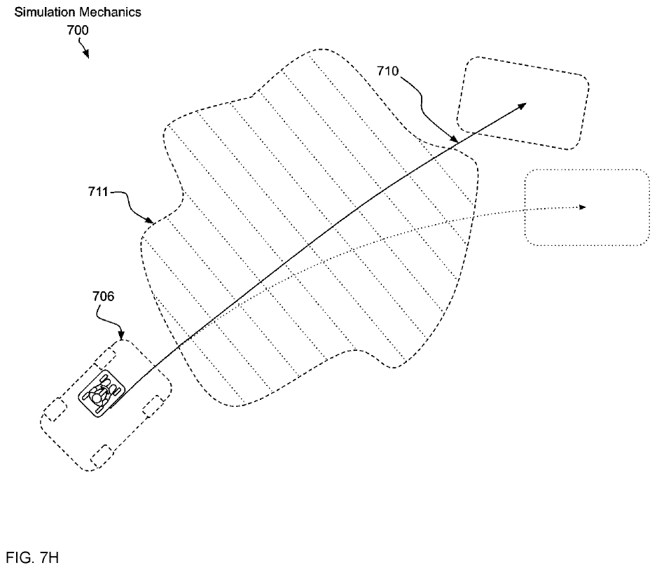

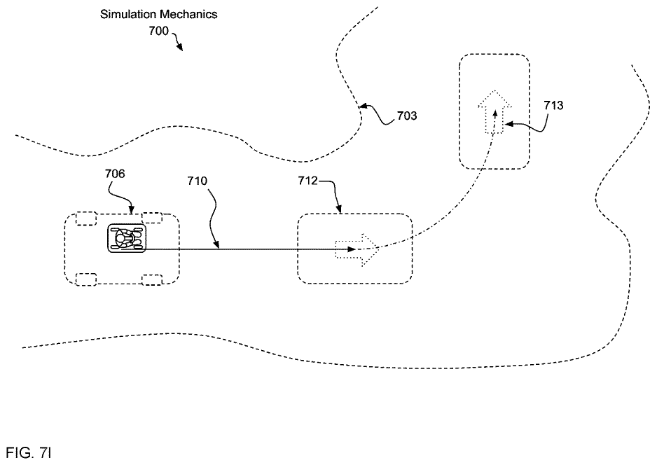

FIG. 7A through 7I are top-down scenes illustrating various operations of the vehicle and control system, including determining the vehicle control commands when a virtual vehicle interacts with a virtual environment.

FIG. 7A illustrates a virtual environment 703 overlaid onto a physical environment 704. The virtual environment 703 is shaped and sized in accordance with the shape and size of the physical environment 704, and in such a way that provides ample distances between user accessible virtual areas and any structure or obstructions in the physical environment 704.

A user 705 situated on or in a physical vehicle 701 traversing the physical environment 704 is constrained to the user accessible virtual areas by means of the virtual boundaries 722. A virtual vehicle 706 is overlaid onto the physical vehicle 701. The virtual vehicle 706 is configured to rotate and translate within the virtual environment 703 in accordance with the position and orientation of the physical vehicle 701 within the physical environment 704 by means of the tracking system 406 of FIG. 4.

The virtual vehicle 706 may be a different size, shape, and anatomy from the physical vehicle 701, and may be anchored offset from the physical vehicle 701.

A projected virtual vehicle 707, representing the intended trajectory of the virtual vehicle 706, extends outward in the direction of motion from the virtual vehicle 706 following the arc 610 of FIG. 6D.

The virtual boundaries 722 prevent the passing of both the virtual vehicle 706 and the projected virtual vehicle 707, guiding the commanded motion of the physical vehicle 701.

FIG. 7B illustrates a virtual environment 703 overlaid onto a physical environment 704. The virtual environment 703 is shaped in accordance with the shape of the physical environment 704 and sized differently than the physical environment 704. As the physical vehicle 701 moves, the virtual environment 703 translates an amount 709 proportional to an amount the vehicle translates 708. Within the virtual environment 703, it would appear as if the virtual vehicle 706 were traveling at an exaggerated velocity.

FIG. 7C illustrates the position and orientation of a projected virtual vehicle 707 being adjusted to reflect the updated virtual vehicle 706 kinematics and desired operational controls from the user.

The linear velocity and angular velocity of the virtual vehicle 706, the linear velocity and angular velocity commands of the user controls, and virtual vehicle 706 parameters, are used in some combination to determine a desired virtual vehicle trajectory 710 and therefore a position and orientation of the projected virtual vehicle 707 with respect to the virtual vehicle 706.

FIG. 7D illustrates the position and orientation of a projected virtual vehicle 707 being adjusted such that the area of the projected virtual vehicle 707 does not intersect or interfere with the area of the virtual boundary 722. The virtual vehicle trajectory 710 is adjusted as a result.

FIG. 7E illustrates the position and orientation of a projected virtual vehicle 707 being adjusted such that the area of the projected virtual vehicle 707 does not intersect or interfere with the area of another projected virtual vehicle 707. The virtual vehicle trajectory 710 is adjusted as a result.

FIG. 7F illustrates the position and orientation of a projected virtual vehicle 707 being adjusted such that the area of the projected virtual vehicle 707 does not intersect or interfere with the area of a virtual vehicle 706. The virtual vehicle trajectory 710 is adjusted as a result.

FIG. 7G illustrates the arc length L_{PP} and arc angle θ_{PP} of the virtual vehicle trajectory 710 being used to update the vehicle control model 600 of FIG. 6D in order to determine appropriate wheel orientation and wheel velocity commands to be relayed to the physical vehicle 701.

FIG. 7H illustrates the trajectory 710 of a virtual vehicle 706 being adjusted as a result of an area 711 of the virtual environment 703 of FIG. 7A possessing a friction property which differs from the friction property of other areas of the virtual environment 703 of FIG. 7A.

FIG. 7I illustrates the trajectory 710 of a virtual vehicle 706 being adjusted such that the virtual vehicle 706 traverses towards or through a virtual vehicle keyframe 712. Each virtual vehicle keyframe 712 may indicate a desired orientation 713 for the virtual vehicle 706 to achieve as their positions align in the virtual environment 703. Each virtual vehicle keyframe 712 may possess other parameters such as pass-through linear and angular velocity, as well as activation and deactivation conditions.

While example embodiments have been particularly shown and described, it will be understood by those skilled in the art that various changes in form and details may be made therein without departing from the scope of the embodiments encompassed by the appended claims.

1. A vehicle, comprising:
a chassis;
a plurality of drive subsystems coupled to the chassis, each including:
a wheel,
a drive motor configured to drive the wheel about an axle, and
a steering motor configured to control rotation of the wheel about a vertical axis;
an accelerometer configured to measure a lateral force exhibited by the chassis; and
a controller configured to:
parse drive commands and odometry data generated by the drive motors and steering motors,
control the steering motors to adjust orientation of the wheels as a function of the drive commands, the lateral force, and the odometry data, and
control the drive motors to adjust velocity of the wheels as a function of the drive commands, the lateral force, and the odometry data.

2. The vehicle of claim 1, wherein the controller adjusts the orientation and velocity of the wheels based on a drive schema, the drive schema defining how the lateral force and odometry data determine the orientation and velocity of the wheels.

3. The vehicle of claim 2, wherein further comprising a control mode selector switch configured to select the drive schema from a plurality of drive schemas.

4. The vehicle of claim 1, wherein the adjusted orientation and velocity of the wheels are distinct from an orientation and velocity determined based on the drive commands and independent of the lateral force and odometry data.

5. The vehicle of claim 1, wherein the controller is further configured to:
update a geometric model based on the drive commands, the lateral force, and the odometry data; and
adjust the orientation and velocity of the wheels based on the geometric model.

6. The vehicle of claim 5, further comprising a control knob configured to adjust parameters of the geometric model.

7. The vehicle of claim 6, wherein the control knob adjusts a traction parameter.

8. The vehicle of claim 6, wherein the control knob adjusts a pivot point parameter.

9. The vehicle of claim 1, further comprising a wireless transceiver configured to communicate with a remote control unit to relay user controls, wheel orientation, and velocity.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)
